(19) United States
(12) Patent Application Publication
(10) Pub. No.: US 2018/0151887 A1
(43) Pub. Date: May 31, 2018

(54) COATED LITHIUM METAL NEGATIVE ELECTRODE

(71) Applicant: GM GLOBAL TECHNOLOGY OPERATIONS LLC, DETROIT, MI (US)

(72) Inventors: Li Yang, Troy, MI (US); Mei Cai, Bloomfield Hills, MI (US); Fang Dai, Troy, MI (US); Gayatri V. Dadheech, Bloomfield Hills, MI (US)

(21) Appl. No.: 15/363,445

(22) Filed: Nov. 29, 2016

(51) Int. Cl. H01M 4/62; H01M 4/04; H01M 4/38; H01M 10/42; H01M 10/052; H01M 2/16; H01M 4/36

(52) U.S. Cl. CPC H01M 4/628; H01M 4/0404; H01M 4/382; H01M 2004/027; H01M 10/052; H01M 2/1653; H01M 4/366; H01M 10/4235

(57) ABSTRACT

An example of a negative electrode includes a lithium metal active material and a coating disposed on the lithium metal active material. The coating consists of one of: (i) a polymeric ionic liquid; or (ii) a VEC polymer formed from vinyl ethylene carbonate; or (iii) a homo-polymer formed from ethylene glycol methyl ether methacrylate, triethylene glycol methyl ether methacrylate, or polyethylene glycol methyl ether methacrylate; or (iv) a combination of any two or more of (i), (ii), and (iii).

### INTRODUCTION

Secondary, or rechargeable, lithium-based batteries are often used in many stationary and portable devices, such as those encountered in the consumer electronic, automobile, and aerospace industries. The lithium class of batteries has gained popularity for various reasons, including a relatively high energy density, a general nonappearance of any memory effect when compared to other kinds of rechargeable batteries, a relatively low internal resistance, and a low self-discharge rate when not in use. The ability of lithium batteries to undergo repeated power cycling over their useful lifetimes makes them an attractive and dependable power source.

### SUMMARY

An example of a negative electrode includes a lithium metal active material and a coating disposed on the lithium metal active material. The coating consists of one of: (i) a polymeric ionic liquid; or (ii) a VEC polymer formed from vinyl ethylene carbonate; or (iii) a homo-polymer formed from ethylene glycol methyl ether methacrylate, triethylene glycol methyl ether methacrylate, or polyethylene glycol methyl ether methacrylate; or (iv) a combination of any two or more of (i), (ii), and (iii).

The negative electrode, with the coating disposed on the lithium metal active material, may be incorporated into a lithium-based battery. The lithium-based battery also includes a positive electrode and a microporous polymer separator soaked in an electrolyte solution. The microporous polymer separator is disposed between the positive electrode and the negative electrode.

In an example of a method for forming a negative electrode, a lithium metal electrode is provided. A coating precursor is applied on the lithium metal electrode. The coating precursor consists of one of: (a) an ionic liquid including a cation selected from the group consisting of a pyrrolidinium-based cation, a piperidinium-based cation, and combinations thereof, wherein the cation has a vinyl or allyl group thereon; and an anion selected from the group consisting of bis(fluorosulfonyl)imide, bis(trifluoromethanesulfonyl)imide, and combinations thereof; or (b) vinyl ethylene carbonate; or (c) ethylene glycol methyl ether methacrylate, triethylene glycol methyl ether methacrylate, or polyethylene glycol methyl ether methacrylate; or (d) a combination of any two or more of (a), (b), and (c). Then, the coating precursor is polymerized directly on the lithium metal electrode to form a coating on the lithium metal electrode.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic, cross-sectional view of an example of the negative electrode disclosed herein, including an example of the coating disposed on the lithium metal active material, which is on a current collector;

FIG. 2 is a schematic, cross-sectional view of an example of a lithium sulfur battery including an example of the negative electrode disclosed herein;

FIG. 3 is a schematic, cross-sectional view of an example of a lithium ion battery including an example of the negative electrode disclosed herein;

FIG. 4 is a schematic, cross-sectional view of an example of a lithium metal battery including an example of the negative electrode disclosed herein; and

FIG. 5 is a graph illustrating the efficiency retention (Y axis, labeled “E”) versus the cycle number (X axis, labeled “#”) of an example battery including an example of the negative electrode disclosed herein and of a comparative battery.

### DETAILED DESCRIPTION

Lithium-based batteries generally operate by reversibly passing lithium ions between a negative electrode (sometimes called an anode) and a positive electrode (sometimes called a cathode). The negative and positive electrodes are situated on opposite sides of a porous polymer separator soaked with an electrolyte solution that is suitable for conducting the lithium ions. During charging, lithium ions are inserted (e.g., intercalated, alloyed, etc.) into the negative electrode, and during discharging, lithium ions are extracted from the negative electrode. Each of the electrodes is also associated with respective current collectors, which are connected by an interruptible external circuit that allows an electric current to pass between the negative and positive electrodes. Examples of lithium-based batteries include a lithium sulfur battery (i.e., includes a sulfur based positive electrode paired with a lithium metal negative electrode), a lithium ion battery (i.e., includes a non-lithium positive electrode paired with a lithium metal negative electrode), and a lithium metal battery (i.e., includes a lithium based positive electrode and a lithium metal negative electrode).

Lithium metal may be used as the active material for a negative electrode. Lithium metal has high energy density. However, lithium metal electrodes tend to form dendrites during cell cycling or after cell cycling. Dendrites are thin conductive filaments (which may have a treelike structure) formed from migrating lithium metal. Dendrites can short the cell, reduce the cell's abuse tolerance, and reduce the overall life of the cell.

Polymeric coatings can impose stack pressure on lithium metal electrodes to render blunt and thick lithium deposits rather than sharp dendrites. However, most polymers need to be dissolved in a solvent in order to be coated, and some solvents that are capable of dissolving the polymer are also not compatible with lithium metal. Solvents that are not compatible with lithium metal include water, acetonitrile, N-methyl-2-pyrrolidone (NMP), dimethylsulfoxide (DMSO), dimethylformamide (DMF), and the like. These solvents may instantly corrode the lithium metal if they are used to coat the lithium with the polymer. Alternative methods, such as vacuum depositing lithium onto a formed polymer film, may be expensive.

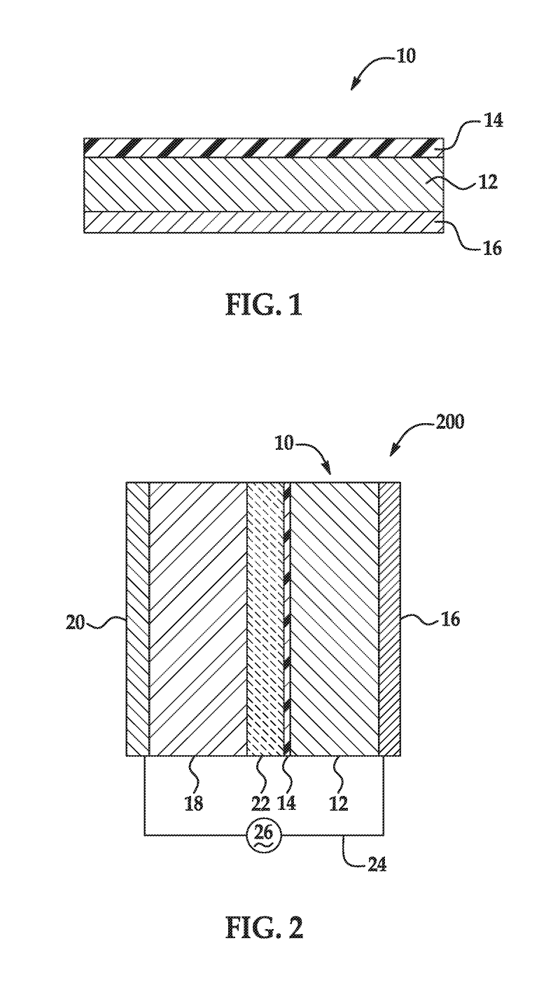

In the negative electrode 10 (see FIG. 1) disclosed herein, lithium metal active material 12 has a coating 14 disposed thereon. The coating 14 consists of one of: (i) a polymeric ionic liquid; or (ii) a VEC polymer formed from vinyl ethylene carbonate; or (iii) a homo-polymer formed from ethylene glycol methyl ether methacrylate, triethylene glycol methyl ether methacrylate, or polyethylene glycol methyl ether methacrylate; or (iv) a combination of (i), (ii), and (iii). FIG. 1 schematically illustrates an example of the negative electrode 10 including the lithium metal active material/electrode 12, the coating 14, and a negative side current collector 16.

The method disclosed herein includes applying a coating precursor on the lithium metal electrode 12 and polymerizing the coating precursor directly on the lithium metal electrode 12, thereby forming the coating 14 on the lithium metal electrode 12. Thus, the method does not use an expensive vacuum deposition process. The method also does not use a solvent that is incompatible with the lithium metal electrode 12. In some examples, the coating precursor is applied on the lithium metal electrode 12 without any solvent. Thus, the lithium metal active material 12 may be free or substantially free from corrosion as a result of solvent exposure. In another example, corrosion of the lithium metal active material 12 due to solvent exposure may be reduced.

The method for forming the negative electrode 10 includes providing a lithium metal electrode 12. In an example, the lithium metal electrode 12 is lithium foil. The lithium metal electrode 12 may have a thickness that ranges from about 5 μm to about 200 μm. In another example, the thickness of the lithium metal electrode 12 ranges from about 10 μm to about 100 μm.

The method also includes applying the coating precursor on the lithium metal electrode 12. Applying the coating precursor may be accomplished by pouring the coating precursor dropwise on the lithium metal electrode 12. In an example, the coating precursor may be a liquid at room temperature (e.g., a temperature ranging from about 18° C. to 22° C.). In these examples, the applying of the coating precursor may be accomplished without a solvent. Thus, as mentioned above, the lithium metal active material 12 with the coating 14 thereon may be free or substantially free from corrosion because incompatible solvents (e.g., water, acetonitrile, NMP, DMSO, DMF, etc.), which may instantly corrode the lithium metal active material 12, are not used to apply the coating precursor.

The coating precursor may consists of: (a) an ionic liquid; or (b) vinyl ethylene carbonate; or (c) ethylene glycol methyl ether methacrylate, triethylene glycol methyl ether methacrylate, or polyethylene glycol methyl ether methacrylate; or (d) a combination of any two or more of (a), (b), and (c).

In some examples, the coating precursor includes (a), the ionic liquid. The coating precursor may be said to include (a) when the coating precursor consists of (a) or when the coating precursor consists of (d) (i.e., a combination of any two or more of (a), (b), and (c)). In these examples, the ionic liquid may include a cation and an anion. The cation may be selected from the group consisting of a pyrrolidinium-based cation, a piperidinium-based cation, and combinations thereof, where the cation has a vinyl or allyl group thereon. Some specific examples of the cation include 1-allyl-1-methylpyrrolidinium, 1-allyl-1-methylpiperidinium, and combinations thereof. The anion may be selected from the group consisting of bis(fluorosulfonyl)imide, bis(trifluoromethanesulfonyl)imide, and combinations thereof. In some examples, the ionic liquid consists of the cation and the anion.

In some other examples, the coating precursor includes (b), vinyl ethylene carbonate. The coating precursor may be said to include (b) when the coating precursor consists of (b) or when the coating precursor consists of (d) (i.e., a combination of any two or more of (a), (b), and (c)).

In still other examples, the coating precursor includes (c), ethylene glycol methyl ether methacrylate, triethylene glycol methyl ether methacrylate, or polyethylene glycol methyl ether methacrylate. The coating precursor may be said to include (c) when the coating precursor consists of (c) or when the coating precursor consists of (d) (i.e., a combination of any two or more of (a), (b), and (c)).

In still other examples, the coating precursor consists of (d), the combination of any two or more of (a), (b), and (c). In these examples, the coating precursor may consist of (a) and (b); (a) and (c); (b) and (c); or (a), (b), and (c). In some of these examples, the combination of any two or more of (a), (b), and (c) may be mixed together to form a single layer in which the respective polymers are present. In others of these examples, the combination may be applied in separate, successive layers of any two or more of (a), (b), and (c) to form separate layers of the corresponding polymeric material (e.g., a layer of (a) to form polymer (i), followed by a layer of (b) to form polymer (ii), or a layer of (a) to form polymer (i) followed by a layer of (c) to form polymer (iii), etc.). In still others of these examples, the combination may be applied in successive layers of any two or more of (a), (b), and (c), where at least one layer consists of a mixture of any two or more of (a), (b), and (c) (e.g., a layer of (a) and (c), followed by a layer of (b), or a layer of (a) and (b) followed by a layer of (a), (b), and (c), etc.). When the combination or a layer of the combination is applied as a mixture of any two or more of (a), (b), and (c), it is believed that the corresponding polymers will self-polymerize separately and form distinct polymers (i.e., polymers (i), (ii), and/or (iii)). It is also believed that in some instances any two or more of (a), (b), and (c) may also co-polymerize and form co-polymer(s) in addition to the distinct polymers (i.e., polymers (i), (ii), and/or (iii)).

After the coating precursor is applied on the lithium metal electrode 12, the method further includes polymerizing the coating precursor directly on the lithium metal electrode 12, to form the coating 14 on the lithium metal electrode 12. In some examples, the coating 14 consists of a polymer formed by the polymerization of the coating precursor. The polymerization of the coating precursor may be accomplished by exposing the lithium metal electrode 12 with the coating precursor thereon to ultraviolet (UV) light, a heat treatment, or a plasma treatment.

Exposure to UV light may be accomplished using a UV light source, such as an ultraviolet (UV) lamp or UV light emitting diode (UV LED). In an example, the UV light, to which the lithium metal electrode 12 with the coating precursor thereon is exposed, has a wavelength ranging from about 10 nm to about 400 nm.

In the examples of the method in which the coating precursor is polymerized by exposing the lithium metal electrode 12 with the coating precursor thereon to UV light, the method may further include applying an ultraviolet (UV) initiator on the lithium metal electrode 12 prior to the polymerization. The UV initiator may be mixed with the coating precursor and applied to the lithium metal electrode 12 in the manner previously described. In these examples, the UV initiator may be utilized in the polymerization of the coating precursor. In other words, the UV initiator may absorb the UV light and generate free radicals, which react with double bonds causing chain reaction and polymerization. In an example, the UV initiator may be methyl benzoylformate. In another example, the UV initiator consists of methyl benzoylformate.

The polymerization of the coating precursor via UV light and/or the inclusion of the UV initiator on the lithium metal electrode 12 may be used when the coating precursor consists of (a), (b), (c), or (d).

Exposure to the heat treatment may be accomplished using a heat source, such as a heat lamp, a furnace, or a conventional oven. The temperature used during the heat treatment may depend upon the coating precursor(s) used and the reaction or polymerization temperature of the coating precursor(s). In an example, the temperature used during the heat treatment may range from about 50° C. to about 80° C.

In the examples of the method in which the coating precursor is polymerized by exposing the lithium metal electrode 12 with the coating precursor thereon to a heat treatment, the method may further include applying a thermal initiator on the lithium metal electrode 12 prior to the polymerization. The thermal initiator may be mixed with the coating precursor and applied to the lithium metal electrode 12 in the manner previously described. In these examples, the thermal initiator may be utilized in the polymerization of the coating precursor. In other words, the thermal initiator may decompose rapidly at the polymer-processing temperature to generate free radicals, which react with double bonds causing chain reaction and polymerization. In an example, the thermal initiator may include azobisisobutyronitrile (AIBN), benzoyl peroxide (BPO), or a combination thereof. In another example, the thermal initiator consists of azobisisobutyronitrile, benzoyl peroxide, or a combination thereof.

The polymerization of the coating precursor via heat treatment and/or the inclusion of the thermal initiator on the lithium metal electrode 12 may be used when the coating precursor consists of (a), (b), (c), or (d).

Exposure to the plasma treatment may be accomplished using a plasma source, such as a plasma chamber. The temperature used during the plasma treatment may depend upon the coating precursor(s) used and the reaction or polymerization temperature of the coating precursor(s). In an example, the temperature used during the plasma treatment may range from about 30° C. to about 110° C. In another example, the temperature used during the plasma treatment may range from about 55° C. to about 60° C.

When the coating precursor consists of (a), (b), (c), or (d), the polymerization of the coating precursor may be accomplished via the plasma treatment. When the plasma treatment is used for polymerization of the coating precursor, the previously described thermal initiator may also be applied on the lithium metal electrode 12 with the coating precursor.

In some examples, the method may also include applying a crosslinker on the lithium metal electrode 12 prior to the polymerization. The crosslinker may be mixed with the coating precursor and applied to the lithium metal electrode 12 in the manner previously described. In these examples, the crosslinker may be utilized in the polymerization of the coating precursor. In other words, the crosslinker may form a bond between the polymer chains that are formed. These bonds can adjust the coating's mechanic performance to improve dendrite suppression and lithium ion conduction. In an example, the crosslinker may include poly(ethylene glycol) dimethacrylate, 2,4,6,8-tetramethyl-2,4,6,8-tetravinylcyclotetrasiloxane, or a combination thereof. In another example, the crosslinker consists of poly(ethylene glycol) dimethacrylate, 2,4,6,8-tetramethyl-2,4,6,8-tetravinylcyclotetrasiloxane, or a combination thereof.

The crosslinker may be used when the coating precursor includes (a) or (c), and when any of the UV light, the heat treatment, or the plasma treatment is used for the polymerization of (a) or (c).

In some examples of the method involving coating precursor (a), the method may consist of providing the lithium metal electrode 12, applying the coating precursor (a) alone on the lithium metal electrode 12, and polymerizing the coating precursor directly on the lithium metal electrode 12 to form the coating 14 on the lithium metal electrode 12. In these examples, the UV initiator, the thermal initiator, and the crosslinker are not applied to the lithium metal electrode 12. In other examples, coating precursor (a) and the crosslinker are applied to the lithium metal electrode 12. In still other examples, coating precursor (a), one of the initiators, and the crosslinker are applied to the lithium metal electrode 12.

In some examples of the method involving coating precursor (b), the method may consist of providing the lithium metal electrode 12, applying the coating precursor (b) and one of the initiators on the lithium metal electrode 12, and polymerizing the coating precursor directly on the lithium metal electrode 12 to form the coating 14 on the lithium metal electrode 12. In these examples, the crosslinker is not applied to the lithium metal electrode 12.

In some examples of the method involving coating precursor (c), the method may consist of providing the lithium metal electrode 12, applying the coating precursor (c) and one of the initiators on the lithium metal electrode 12, and polymerizing the coating precursor directly on the lithium metal electrode 12 to form the coating 14 on the lithium metal electrode 12. In these examples, the crosslinker may or may not be applied to the lithium metal electrode 12.

The coating 14, formed by polymerizing the coating precursor, consists of one of: (i) a polymeric ionic liquid; or (ii) a VEC polymer formed from vinyl ethylene carbonate; or (iii) a homo-polymer formed from ethylene glycol methyl ether methacrylate, triethylene glycol methyl ether methacrylate, or polyethylene glycol methyl ether methacrylate; or (iv) a combination of any two or more of (i), (ii), and (iii). It is to be understood that the polymeric ionic liquid or the homo-polymer may be a crosslinked species, as long as the crosslinker is used during its formation.

In some examples, the coating 14 includes (i), the polymeric ionic liquid. The coating 14 may be said to include (i) when the coating 14 consists of (i) or when the coating 14 consists of (iv).

When the coating 14 includes (i), the coating precursor includes coating precursor (a). In these examples, the polymeric ionic liquid may be formed from a cation selected from the group consisting of a pyrrolidinium-based cation, a piperidinium-based cation, and combinations thereof, where the cation has a vinyl or allyl group thereon; and an anion selected from the group consisting of bis(fluorosulfonyl)imide, bis(trifluoromethanesulfonyl)imide, and combinations thereof. As mentioned above, some specific examples of the cation include 1-allyl-1-methylpyrrolidinium, 1-allyl-1-methylpiperidinium, and combinations thereof. In some of these examples, the polymeric ionic liquid may be formed from the cation and the anion alone. In others of these examples, the polymeric ionic liquid may be formed from the cation and the anion in combination with the UV initiator or the thermal initiator, and/or the crosslinker. When the UV initiator is used, the UV initiator may be present in an amount ranging from greater than 0 wt % to about 5 wt % based on the total wt % of the polymeric ionic liquid. When the thermal initiator is used, the thermal initiator may be present in an amount ranging from greater than 0 wt % to about 5 wt % based on the total wt % of the polymeric ionic liquid. When the crosslinker is used, the crosslinker may be present in an amount ranging from greater than 0 wt % to about 5 wt % based on the total wt % of the polymeric ionic liquid.

In some other examples, the coating 14 includes (ii), the VEC polymer. The coating 14 may be said to include (ii) when the coating 14 consists of (ii) or when the coating 14 consists of (iv).

When the coating 14 includes (ii), the coating precursor includes coating precursor (b). In these examples, the VEC polymer may be formed from vinyl ethylene carbonate in combination with the UV initiator or the thermal initiator. When used, the UV initiator may be present in an amount ranging from greater than 0 wt % to about 5 wt % based on the total wt % of the VEC polymer. In another example, the UV initiator may be present in an amount ranging from about 0.05 wt % to about 1 wt % based on the total wt % of the VEC polymer. When used, the thermal initiator may be present in an amount ranging from greater than 0 wt % to about 5 wt % based on the total wt % of the VEC polymer. In still another example, the thermal initiator may be present in an amount ranging from about 0.05 wt % to about 1 wt % based on the total wt % of the VEC polymer.

In still other examples, the coating 14 includes (iii), the homo-polymer. The coating 14 may include (iii) when the coating 14 consists of (iii) or when the coating 14 consists of (iv).

When the coating 14 includes (iii), the coating precursor includes coating precursor (c). In these examples, the homo-polymer may be formed ethylene glycol methyl ether methacrylate, triethylene glycol methyl ether methacrylate, or polyethylene glycol methyl ether methacrylate, in combination with the UV initiator or the thermal initiator, and/or the crosslinker. When the UV initiator is used, the UV initiator may be present in an amount ranging from greater than 0 wt % to about 5 wt % based on the total wt % of the homo-polymer. When the thermal initiator is used, the thermal initiator may be present in an amount ranging from greater than 0 wt % to about 10 wt % based on the total wt % of the homo-polymer. When the crosslinker is used, the crosslinker may be present in an amount ranging from greater than 0 wt % to about 10 wt % based on the total wt % of the homo-polymer.

In still other examples, the coating 14 consists of (iv). In these examples, the coating 14 may be a composite that consists of (i) and (ii); (i) and (iii); (ii) and (iii); or (i), (ii), and (iii). In some of these examples, the composite that consists of (i) and (ii); (i) and (iii); (ii) and (iii); or (i), (ii), and (iii) may be mixed together in a single layer. In others of these examples, the composite may consist of separate, successive layers of (i) and (ii); (i) and (iii); (ii) and (iii); or (i), (ii), and (iii) (e.g., a layer of (i), followed by a layer of (ii), or a layer of (i) followed by a layer of (iii), etc.). In still others of these examples, the composite may consist of in successive layers, where at least one layer consists of a mixture of (i) and (ii); (i) and (iii); (ii) and (iii); or (i), (ii), and (iii) (e.g., a layer of (i) and (iii), followed by a layer of (ii), or a layer of (i) and (ii) followed by a layer of (i), (ii), and (iii), etc.). When the respective monomers are mixed together to form (iv), they may self-polymerize to form the distinct polymers (i), (ii) and (iii). In some instances, some of the mixed monomers may also co-polymerize, and the resulting copolymer will be among the distinct polymers (i), (ii) and (iii).

In an example of the composite coating consisting of (i), (ii), and (iii), the polymeric ionic liquid (i) is present in an amount ranging from greater than 0 wt % to about 90 wt % based on a total wt % of the coating 14, the VEC polymer (ii) is present in amount ranging from greater than 0 wt % to about 50 wt % based on the total wt % of the coating 14, and the homo-polymer (iii) is present in amount ranging from greater than 0 wt % to about 50 wt % based on the total wt % of the coating 14.

In an example, the coating 14 has a thickness ranging from about 500 nm to about 5000 nm.

The coating 14 may suppress dendrite growth during cycling of a lithium-based battery that has incorporated the negative electrode 10. The coating 14 imposes high stack pressure on the lithium that precipitates during cycling (as compared to the pressure that would be imposed on the lithium by a liquid electrolyte, which may have a value of 0 Gpa). This pressure causes the precipitated lithium to form blunt and thick lithium deposits rather than sharp dendrites that may extend to the positive electrode. In an example, the pressure imposed on the lithium by the coating 14 may higher than 1 Gpa.

The coating 14 is also able to conduct lithium ions. The coating 14 allows the lithium ions to travel from the lithium metal active material 12 through the coating 14 to the electrolyte and across the battery. Thus, lithium-based batteries, with the negative electrode 10 incorporated therein, are able to charge and discharge.

After obtaining the negative electrode 10 (i.e., lithium metal active material/electrode 12 having the coating 14 disposed thereon), the negative electrode 10 may be added to a lithium-based battery 200, 300, 400 (see FIGS. 2-4). In general, the cell/battery 200, 300, 400 may be assembled with the negative electrode 10, a suitable positive electrode 18, 18′, 18″ (examples of which will be described below), a microporous polymer separator 22 positioned between the negative and positive electrodes 10 and 18 or 18′ or 18″, and an example of the electrolyte disclosed herein including a suitable solvent for the particular battery type.

Lithium Sulfur Battery/Electrochemical Cell

An example of a lithium sulfur battery 200 is shown in FIG. 2. For the lithium sulfur battery/electrochemical cell 200, the negative electrode 10 (i.e., lithium metal active material 12 with the coating 14 disposed thereon) may be used.

The positive electrode 18 of the lithium sulfur battery 200 includes any sulfur-based active material that can sufficiently undergo lithium alloying and dealloying with cooper, nickel, aluminum or another suitable current collector 20 functioning as the positive terminal of the lithium sulfur electrochemical cell 200. An example of the sulfur-based active material is a sulfur-carbon composite. In an example, the weight ratio of S to C in the positive electrode 18 ranges from 1:9 to 9:1.

The positive electrode 18 in the lithium sulfur battery 200 may include a binder material or a conductive filler. The binder material may be used to structurally hold the active material together. Examples of the binder material include polyvinylidene fluoride (PVdF), polyethylene oxide (PEO), an ethylene propylene diene monomer (EPDM) rubber, carboxymethyl cellulose (CMC), styrene-butadiene rubber (SBR), styrene-butadiene rubber carboxymethyl cellulose (SBR-CMC), polyacrylic acid (PAA), cross-linked polyacrylic acid-polyethylenimine, polyimide, or any other suitable binder material. Examples of the still other suitable binders include polyvinyl alcohol (PVA), sodium alginate, or other water-soluble binders.

The conductive filler material may be a conductive carbon material. The conductive carbon material may be a high surface area carbon, such as acetylene black or another carbon material (e.g., Super P). Other examples of suitable conductive fillers include graphene, graphite, carbon nanotubes, and/or carbon nanofibers. The conductive filler material is included to ensure electron conduction between the active material and the positive-side current collector 20 in the battery 200.

The microporous polymer separator 22 may be formed, e.g., from a polyolefin. The polyolefin may be a homopolymer (derived from a single monomer constituent) or a heteropolymer (derived from more than one monomer constituent), and may be either linear or branched. If a heteropolymer derived from two monomer constituents is employed, the polyolefin may assume any copolymer chain arrangement including those of a block copolymer or a random copolymer. The same holds true if the polyolefin is a heteropolymer derived from more than two monomer constituents. As examples, the polyolefin may be polyethylene (PE), polypropylene (PP), a blend of PE and PP, or multi-layered structured porous films of PE and/or PP. Commercially available porous separators 22 include single layer polypropylene membranes, such as CELGARD 2400 and CELGARD 2500 from Celgard, LLC (Charlotte, N.C.). It is to be understood that the microporous separator 22 may be coated or treated, or uncoated or untreated. For example, the microporous separator 22 may or may not be coated or include any surfactant treatment thereon.

In other examples, the microporous separator 22 may be formed from another polymer chosen from polyethylene terephthalate (PET), polyvinylidene fluoride (PVdF), polyamides (Nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polyolefin copolymers, acrylonitrile-butadiene styrene copolymers (ABS), polystyrene copolymers, polymethylmethacrylate (PMMA), polyvinyl chloride (PVC), polysiloxane polymers (such as polydimethylsiloxane (PDMS)), polybenzimidazole (PBI), polybenzoxazole (PBO), polyphenylenes (e.g., PARMAX (Mississippi Polymer Technologies, Inc., Bay Saint Louis, Miss.)), polyarylene ether ketones, polyperfluorocyclobutanes, polytetrafluoroethylene (PTFE), polyvinylidene fluoride copolymers and terpolymers, polyvinylidene chloride, polyvinylfluoride, liquid crystalline polymers (e.g., VECTRAN™ (Hoechst AG, Germany) and ZENITE® (DuPont, Wilmington, Del.)), polyaramides, polyphenylene oxide, and/or combinations thereof. It is believed that another example of a liquid crystalline polymer that may be used for the microporous separator 22 is poly(p-hydroxybenzoic acid). In yet another example, the microporous separator 22 may be chosen from a combination of the polyolefin (such as PE and/or PP) and one or more of the other polymers listed above.

The microporous separator 22 may be a single layer or may be a multi-layer (e.g., bilayer, trilayer, etc.) laminate fabricated from either a dry or wet process. For example, a single layer of the polyolefin and/or other listed polymer may constitute the entirety of the microporous polymer separator 22. As another example, however, multiple discrete layers of similar or dissimilar polyolefins and/or polymers may be assembled into the microporous polymer separator 22. In one example, a discrete layer of one or more of the polymers may be coated on a discrete layer of the polyolefin to form the microporous polymer separator 22. Further, the polyolefin (and/or other polymer) layer, and any other optional polymer layers, may further be included in the microporous polymer separator 22 as a fibrous layer to help provide the microporous polymer separator 22 with appropriate structural and porosity characteristics. Still other suitable microporous polymer separators 22 include those that have a ceramic layer attached thereto, and those that have ceramic filler in the polymer matrix (i.e., an organic-inorganic composite matrix).

The microporous separator 22 operates as both an electrical insulator and a mechanical support, and is sandwiched between the negative electrode 10 and the positive electrode 18 to prevent physical contact between the two electrodes 10, 18 and the occurrence of a short circuit. In addition to providing a physical barrier between the electrodes 10, 18, the microporous polymer separator 22 ensures passage of lithium ions through the electrolyte filling its pores.

The negative electrode 10, the sulfur-based positive electrode 18, and the microporous separator 22 are soaked with the electrolyte (not shown), including a solvent suitable for the lithium sulfur battery 200 and a lithium salt.

In an example, the solvent suitable for the lithium sulfur battery 200 may be an ionic liquid. When the ionic liquid is used as the solvent, the ionic liquid may include a cation and an anion. The cation may be selected from the group consisting of a pyrrolidinium-based cation, a piperidinium-based cation, and combinations thereof. In an example, the cation may have a vinyl or allyl group thereon. Some specific examples of the cation include 1-allyl-1-methylpyrrolidinium, 1-allyl-1-methylpiperidinium, and combinations thereof. The anion may be a fluorosulfonyl imide-based anion. Some specific examples of the anion include bis(fluorosulfonyl)imide, bis(trifluoromethanesulfonyl)imide, and combinations thereof.

In another example, the solvent suitable for the lithium sulfur battery 200 may be an ether-based solvent. Examples of the ether-based solvent include cyclic ethers, such as 1,3-dioxolane, tetrahydrofuran, 2-methyltetrahydrofuran, and chain structure ethers, such as 1,2-dimethoxyethane, 1-2-diethoxyethane, ethoxymethoxyethane, tetraethylene glycol dimethyl ether (TEGDME), polyethylene glycol dimethyl ether (PEGDME), ethyl ether, aliphatic ethers, polyethers, and mixtures thereof.

Examples of the lithium salt that may be dissolved in the ionic liquid solvent(s) and/or in the ether(s) include LiPF₆, LiClO₄, LiAlCl₄, LiI, LiBr, LiSCN, LiBF₄, LiB(C₆H₅)₄, LiAsF₆, LiCF₃SO₃, LiN(FSO₂)₂ (LIFSI), LiN(CF₃SO₂)₂ (LITFSI or lithium bis(trifluoromethylsulfonyl)imide), LiB(C₂O₄)₂ (LiBOB), LiBF₂(C₂O₄) (LiODFB), LiPF₃(C₂F₅)₃ (LiFAP), LiPF₄(CF₃)₂, LiPF₄(C₂O₄) (LiFOP), LiPF₃(CF₃)₃, LiSO₃CF₃, LiNO₃, and mixtures thereof.

Lithium Ion Battery/Electrochemical Cell

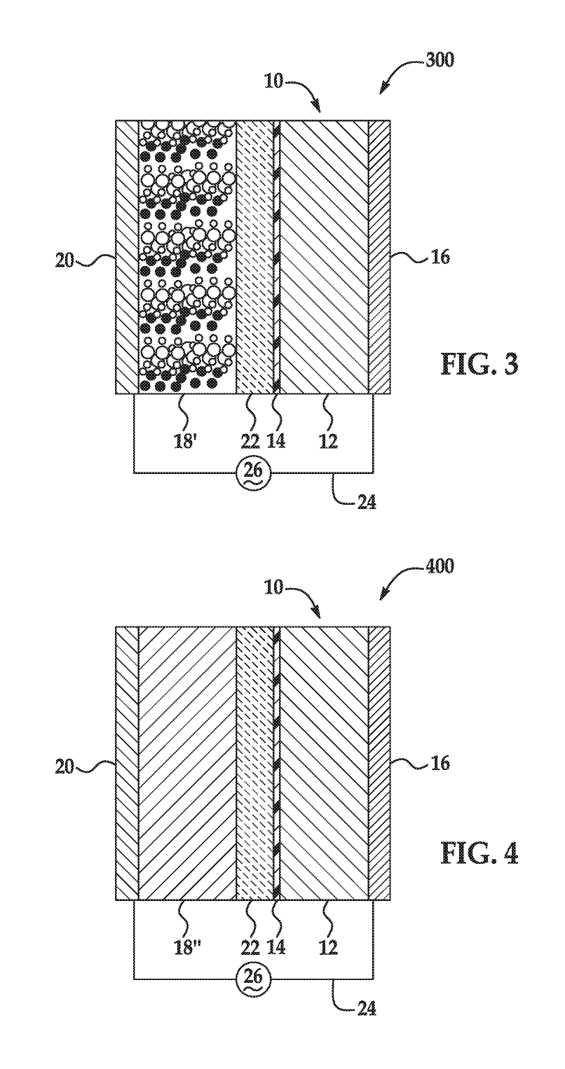

An example of a lithium ion battery 300 is shown in FIG. 3. For the lithium ion battery/electrochemical cell 300, the negative electrode 10 (i.e., lithium metal active material 12 with the coating 14 disposed thereon) may be used.

The positive electrode 18′ of the lithium ion battery 300 may include any lithium-based or non-lithium-based active material that can sufficiently undergo lithium insertion and deinsertion with copper, nickel, aluminum or another suitable current collector 20 functioning as the positive terminal of the lithium ion electrochemical cell.

One common class of known lithium-based active materials suitable for this example of the positive electrode 18′ includes layered lithium transition metal oxides. For example, the lithium-based active material may be spinel lithium manganese oxide (LiMn₂O₄), lithium cobalt oxide (LiCoO₂), a manganese-nickel oxide spinel [Li(Mn_{1.5}Ni_{0.5})O₂], or a layered nickel-manganese-cobalt oxide (having a general formula of xLi₂MnO₃.(1-x)LiMO₂ or (M is composed of any ratio of Ni, Mn and/or Co). A specific example of the layered nickel-manganese-cobalt oxide includes (xLi₂MnO₃. (1-x)Li(Ni_{1/3}Mn_{1/3}CO_{1/3})O₂). Other suitable lithium-based active materials include Li(Ni_{1/3}Mn_{1/3}Co_{1/3})O₂, Li_{x+y}Mn_{2-y}O₄ (LMO, 0<x<1 and 0<y<0.1), or a lithium iron polyanion oxide, such as lithium iron phosphate (LiFePO₄) or lithium iron fluorophosphate (Li₂FePO₄F), or a lithium rich layer-structure. Still other lithium-based active materials may also be utilized, such as LiNi₁₋ₓCo_{1-y}M_{x+y}O₂ or LiMn_{1.5-x}Ni_{0.5-y}M_{x+y}O₄ (M is composed of any ratio of Al, Ti, Cr, and/or Mg), stabilized lithium manganese oxide spinel (LiₓMn_{2-y}M_{y}O₄, where M is composed of any ratio of Al, Ti, Cr, and/or Mg), lithium nickel cobalt aluminum oxide (e.g., LiNi_{0.8}Co_{0.15}Al_{0.05}O₂) or NCA), aluminum stabilized lithium manganese oxide spinel (e.g., LiₓAl_{0.05}Mn_{0.95}O₂), lithium vanadium oxide (LiV₂O₅), Li₂MSiO₄ (where M is composed of any ratio of Co, Fe, and/or Mn), and any other high energy nickel-manganese-cobalt material (HE-NMC, NMC or LiNiMnCoO₂). By “any ratio” it is meant that any element may be present in any amount. So, in some examples, M could be Al, with or without Cr, Ti, and/or Mg, or any other combination of the listed elements. In another example, anion substitutions may be made in the lattice of any example of the lithium transition metal based active material to stabilize the crystal structure. For example, any 0 atom may be substituted with an F atom.

Suitable non-lithium based materials for this example of the positive electrode 18′ include metal oxides, such as manganese oxide (Mn₂O₄), cobalt oxide (CoO₂), a nickel-manganese oxide spinel, a layered nickel-manganese-cobalt oxide, or an iron polyanion oxide, such as iron phosphate (FePO₄) or iron fluorophosphate (FePO₄F), or vanadium oxide (V₂O₅).

The positive electrode 18′ in the lithium ion electrochemical cell/battery 300 may include any of the previously mentioned binder materials and conductive fillers.

The negative electrode 10, the positive electrode 18′, and the microporous separator 22 are soaked with the electrolyte (not shown), including a solvent suitable for the lithium ion battery 300 and a lithium salt.

In an example, the solvent suitable for the lithium ion battery 300 may be an ionic liquid. When the ionic liquid is used as the solvent, the ionic liquid may include a cation and an anion. The cation may be selected from the group consisting of a pyrrolidinium-based cation, a piperidinium-based cation, and combinations thereof. In an example, the cation may have a vinyl or allyl group thereon. Some specific examples of the cation include 1-allyl-1-methylpyrrolidinium, 1-allyl-1-methylpiperidinium, and combinations thereof. The anion may be a fluorosulfonyl imide-based anion. Some specific examples of the anion include bis(fluorosulfonyl)imide, bis(trifluoromethanesulfonyl)imide, and combinations thereof.

In another example, the solvent suitable for the lithium ion battery 300 may be an organic solvent or a mixture of organic solvents. Examples of suitable organic solvents include cyclic carbonates (ethylene carbonate, propylene carbonate, butylene carbonate, fluoroethylene carbonate (FEC)), linear carbonates (dimethyl carbonate (DMC), diethyl carbonate (DEC), ethylmethyl carbonate), aliphatic carboxylic esters (methyl formate, methyl acetate, methyl propionate), γ-lactones (γ-butyrolactone, γ-valerolactone), chain structure ethers (1,2-dimethoxyethane, 1-2-diethoxyethane, ethoxymethoxyethane, tetraglyme), cyclic ethers (tetrahydrofuran, 2-methyltetrahydrofuran,1,3-dioxolane), dioxane, acetonitrile, nitromethane, ethyl monoglyme, phosphoric triesters, trimethoxymethane, dioxolane derivatives, 3-methyl-2-oxazolidinone, propylene carbonate derivatives, tetrahydrofuran derivatives, ethyl ether, 1,3-propanesultone, N-methyl acetamide, acetals, ketals, sulfones, sulfolanes, aliphatic ethers, cyclic ethers, glymes, polyethers, phosphate esters, siloxanes, dioxolanes, N-alkylpyrrolidones, and mixtures thereof.

Examples of the lithium salt that may be dissolved in the ionic liquid solvent(s) and/or in the organic solvent(s) include all of the lithium salts listed above that may be dissolved in the ionic liquid solvent(s) and/or in the ether(s) of the lithium sulfur battery 200.

Lithium Metal Battery/Electrochemical Cell

An example of a lithium metal battery 400 is shown in FIG. 4. For the lithium ion battery/electrochemical cell 300, the negative electrode 10 (i.e., lithium metal active material 12 with the coating 14 disposed thereon) may be used.

The positive electrode 18″ of the lithium metal battery 400 may include any lithium-based active material that can sufficiently undergo lithium insertion and deinsertion with copper, nickel, aluminum or another suitable current collector 20 functioning as the positive terminal of the lithium ion electrochemical cell. Any of the previous lithium-based active materials may be used in the positive electrode 18″ of the lithium metal battery 400, an example of which includes LiFePO₄. The positive electrode 18″ in the lithium metal battery 400 may include any of the previously described binder materials and/or conductive fillers.

The negative electrode 10, the positive electrode 18″, and the microporous separator 22 are soaked with the electrolyte (not shown), including a solvent suitable for the lithium metal battery 400 and a lithium salt.

In an example, the solvent suitable for the lithium metal battery 400 may be an ionic liquid. When the ionic liquid is used as the solvent, the ionic liquid may include a cation and an anion. The cation may be selected from the group consisting of a pyrrolidinium-based cation, a piperidinium-based cation, and combinations thereof. In an example, the cation may have a vinyl or allyl group thereon. Some specific examples of the cation include 1-allyl-1-methylpyrrolidinium, 1-allyl-1-methylpiperidinium, and combinations thereof. The anion may be a fluorosulfonyl imide-based anion. Some specific examples of the anion include bis(fluorosulfonyl)imide, bis(trifluoromethanesulfonyl)imide, and combinations thereof.

In another example, the solvent suitable for the lithium metal battery 400 may be an ether-based solvent. Examples of the ether-based solvent include all of the ether-based solvents listed above in reference to the lithium sulfur battery 200.

In still another example, the solvent suitable for the lithium metal battery 400 may be organic solvent or a mixture of organic solvents. Examples of suitable organic solvents include all of the organic solvents listed above in reference to the lithium ion battery 300.

Examples of the lithium salt that may be dissolved in the ionic liquid solvent(s), in the ether-based solvent(s), and/or in the organic solvent(s) include all of the lithium salts listed above in reference to the lithium sulfur battery 200 or the lithium ion battery 300.

As shown in FIGS. 2-4, the lithium sulfur battery/electrochemical cell 200, the lithium ion battery/electrochemical cell 300, and the lithium metal battery/electrochemical cell 400 each include an interruptible external circuit 24 that connects the negative electrode 10 and the positive electrode 18, 18′, 18″. The lithium sulfur battery/electrochemical cell 200, the lithium ion battery/electrochemical cell 300, and the lithium metal battery/electrochemical cell 400 each may also support a load device 26 that can be operatively connected to the external circuit 24. The load device 26 receives a feed of electrical energy from the electric current passing through the external circuit 24 when the battery 200, 300, 400 is discharging. While the load device 26 may be any number of known electrically-powered devices, a few specific examples of a power-consuming load device 26 include an electric motor for a hybrid vehicle or an all-electrical vehicle, a laptop computer, a cellular phone, and a cordless power tool. The load device 26 may also, however, be an electrical power-generating apparatus that charges the battery 200, 300, 400 for purposes of storing energy. For instance, the tendency of windmills and solar panels to variably and/or intermittently generate electricity often results in a need to store surplus energy for later use.

FIGS. 2-4 also illustrate the porous separator 22 positioned between the electrodes 10, 18, 18′, 18″. Metal contacts/supports (e.g., a copper foil contact/support, a nickel foil contact/support, or an aluminum contact/support) may be made to the electrodes 10, 18, 18′, 18″, examples of which include a negative-side current collector 16 to the negative electrode 10, and a positive-side current collector 20 to the positive electrode 18, 18′, 18″.

The lithium sulfur battery/electrochemical cell 200, the lithium ion battery/electrochemical cell 300, and/or the lithium metal battery/electrochemical cell 400 may also include a wide range of other components that, while not depicted here, are nonetheless known to skilled artisans. For instance, the battery 200, 300, 400 may include a casing, gaskets, terminals, tabs, and any other desirable components or materials that may be situated between or around the negative electrode 10 and the positive electrode 18, 18′, 18″ for performance-related or other practical purposes. Moreover, the size and shape of the battery 200, 300, 400, as well as the design and chemical make-up of its main components, may vary depending on the particular application for which it is designed. Battery-powered automobiles and hand-held consumer electronic devices, for example, are two instances where the battery 200, 300, 400 would most likely be designed to different size, capacity, and power-output specifications. The battery 200, 300, 400 may also be connected in series and/or in parallel with other similar batteries to produce a greater voltage output and current (if arranged in parallel) or voltage (if arranged in series) if the load device 26 so requires.

The lithium sulfur battery/electrochemical cell 200, the lithium ion battery/electrochemical cell 300, and the lithium metal battery/electrochemical cell 400 each generally operates by reversibly passing lithium ions between the negative electrode 10 and the positive electrode 18, 18′, 18″. In the fully charged state, the voltage of the battery 200, 300, 400 is at a maximum (typically in the range 2.0V to 5.0V); while in the fully discharged state, the voltage of the battery 200, 300, 400 is at a minimum (typically in the range 0V to 2.0V). Essentially, the Fermi energy levels of the active materials in the positive and negative electrodes 18, 18′, 18″, 10 change during battery operation, and so does the difference between the two, known as the battery voltage. The battery voltage decreases during discharge, with the Fermi levels getting closer to each other. During charge, the reverse process is occurring, with the battery voltage increasing as the Fermi levels are being driven apart. During battery discharge, the external load device 26 enables an electronic current flow in the external circuit 24 with a direction such that the difference between the Fermi levels (and, correspondingly, the cell voltage) decreases. The reverse happens during battery charging: the battery charger forces an electronic current flow in the external circuit 24 with a direction such that the difference between the Fermi levels (and, correspondingly, the cell voltage) increases.

At the beginning of a discharge, the negative electrode 10 of the battery 200, 300, 400 contains a high concentration of inserted lithium while the positive electrode 18, 18′, 18″ is relatively depleted. When the negative electrode 10 contains a sufficiently higher relative quantity of inserted lithium, the lithium-based battery 200, 300, 400 can generate a beneficial electric current by way of reversible electrochemical reactions that occur when the external circuit 24 is closed to connect the negative electrode 10 and the positive electrode 18, 18′, 18″. The establishment of the closed external circuit 24 under such circumstances causes the extraction of inserted lithium from the negative electrode 10. The extracted lithium atoms are split into lithium ions and electrons as they leave a host (i.e., the lithium metal active material 12) at the negative electrode-electrolyte interface.

The chemical potential difference between the positive electrode 18, 18′, 18″ and the negative electrode 10 (ranging from about 0.005V to about 5.0V, depending on the exact chemical make-up of the electrodes 10, 18, 18′, 18″) drives the electrons produced by the oxidation of inserted lithium at the negative electrode 10 through the external circuit 24 towards the positive electrode 18, 18′, 18″. The lithium ions are concurrently carried by the electrolyte solution through the microporous separator 22 towards the positive electrode 18, 18′, 18″. The electrons flowing through the external circuit 24 and the lithium ions migrating across the microporous separator 22 in the electrolyte solution eventually incorporate, in some form, lithium at the positive electrode 18, 18′, 18″. The electric current passing through the external circuit 24 can be harnessed and directed through the load device 26 until the level of inserted lithium in the negative electrode 10 falls below a workable level or the need for electrical energy ceases.

The battery 200, 300, 400 may be recharged after a partial or full discharge of its available capacity. To charge the battery 200, 300, 400 an external battery charger is connected to the positive and the negative electrodes 18, 18′, 18″, 10 to drive the reverse of battery discharge electrochemical reactions. During recharging, the electrons flow back towards the negative electrode 10 through the external circuit 24, and the lithium ions are carried by the electrolyte across the microporous separator 22 back towards the negative electrode 10. The electrons and the lithium ions are reunited at the negative electrode 10, thus replenishing it with inserted lithium for consumption during the next battery discharge cycle.

The external battery charger that may be used to charge the battery 200, 300, 400 may vary depending on the size, construction, and particular end-use of the battery 200, 300, 400. Some suitable external battery chargers include a battery charger plugged into an AC wall outlet and a motor vehicle alternator.

To further illustrate the present disclosure, examples are given herein. It is to be understood that these examples are provided for illustrative purposes and are not to be construed as limiting the scope of the disclosure.

### Example

An example negative electrode and a comparative negative electrode were prepared. The example negative electrode included the lithium metal active material and the coating disposed on the lithium metal active material. The comparative electrode consisted of the lithium metal active material and did not include a coating.

The coating of the example negative electrode consisted of a polymeric ionic liquid. The coating was formed on the lithium metal by polymerizing 3-Ethyl-1-vinylimidazolium bis(fluorosulfonyl)imide. Polymerization was initiated by UV light with the use of a UV initiator. Microporous tri-layered polypropylene (PP) and polyethylene (PE) polymer membranes (CELGARD 2032, available from Celgard) were used as the separators. The electrolyte used for the example negative electrode/cell and the comparative negative electrode/cell consisted of 1 M LiFSI dissolved in PYR₁₄⁺FSI⁻ ionic liquid plus 10% (v/v) fluorinated ether. The positive electrode in each cell was NMC.

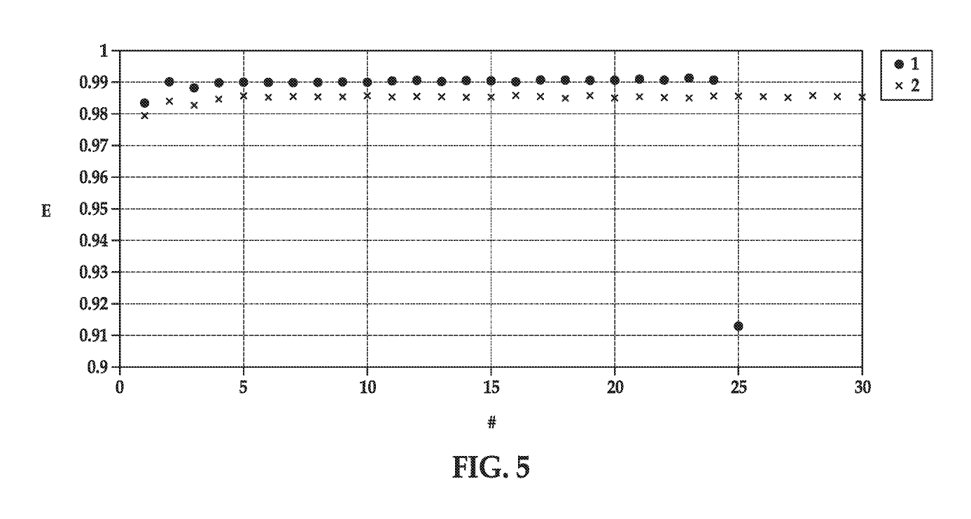

The test conditions for the Li-NMC example and comparative cells were: room temperature; current=500 μA; and voltage window ranging from 3.0 V to 4.3 V. The efficiency retention results are shown in FIG. 5. In FIG. 5, the left Y axis, labeled “E,” represents the efficiency retention (in %/100), and the X axis, labeled “#,” represents the cycle number.

As illustrated in FIG. 5, throughout the cycles, the efficiency retention of the example cell (labeled “1”) was generally higher than the efficiency retention of the comparative cell (labeled “2”). FIG. 5 further illustrates that the example cell is able to achieve a 99.1% efficiency. It is believed that the high efficiency achieved by the example cell is due, at least in part, to the stack pressure imposed on the precipitated lithium by the coating.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range. For example, a range from greater than 0 wt % to about 5 wt % should be interpreted to include not only the explicitly recited limits of from greater than 0 wt % to about 5 wt %, but also to include individual values, such as 0.75 wt %, 2 wt %, 3.5 wt %, 4.2 wt %, etc., and sub-ranges, such as from greater than 0 wt % to about 4.5 wt %, from about 0.7 wt % to about 4.8 wt %, from about 1.75 wt % to about 3.85 wt %, etc. Furthermore, when “about” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A negative electrode, comprising:
a lithium metal active material; and
a coating disposed on the lithium metal active material, the coating consisting of one of:
(i) a polymeric ionic liquid; or
(ii) a VEC polymer formed from vinyl ethylene carbonate; or
(iii) a homo-polymer formed from ethylene glycol methyl ether methacrylate, triethylene glycol methyl ether methacrylate, or polyethylene glycol methyl ether methacrylate; or
(iv) a combination of any two or more of (i), (ii), and (iii).

2. The negative electrode as defined in claim 1 wherein the coating is (i) or (iv) and wherein the polymeric ionic liquid is formed from:
a cation selected from the group consisting of a pyrrolidinium-based cation, a piperidinium-based cation, and combinations thereof, wherein the cation has a vinyl or allyl group thereon; and
an anion selected from the group consisting of bis(fluorosulfonyl)imide, bis(trifluoromethanesulfonyl)imide, and combinations thereof.

3. The negative electrode as defined in claim 1 wherein the coating is (i) or (iv) and wherein the polymeric ionic liquid is formed from:
a cation selected from the group consisting of a pyrrolidinium-based cation, a piperidinium-based cation, and combinations thereof, wherein the cation has a vinyl or allyl group thereon;
an anion selected from the group consisting of bis(fluorosulfonyl)imide, bis(trifluoromethanesulfonyl)imide, and combinations thereof; and
one of:
a crosslinker selected from the group consisting of poly(ethylene glycol) dimethacrylate, 2,4,6,8-tetramethyl-2,4,6,8-tetravinylcyclotetrasiloxane, and combinations thereof; or
an ultraviolet (UV) initiator selected from the group consisting of methyl benzoylformate; or
a thermal initiator selected from the group consisting of azobisisobutyronitrile, benzoyl peroxide, and a combination thereof.

4. The negative electrode as defined in claim 3 wherein the polymeric ionic liquid is formed from the cation, the anion and the crosslinker, and wherein the crosslinker is present in an amount ranging from greater than 0 wt % to about 5 wt % based on a total wt % of the polymeric ionic liquid.

5. The negative electrode as defined in claim 3 wherein the polymeric ionic liquid is formed from the cation, the anion and the UV initiator, and wherein the UV initiator is present in an amount ranging from greater than 0 wt % to about 5 wt % based on a total wt % of the polymeric ionic liquid.

6. The negative electrode as defined in claim 3 wherein the polymeric ionic liquid is formed from the cation, the anion and the thermal initiator, and wherein the thermal initiator is present in an amount ranging from greater than 0 wt % to about 5 wt % based on a total wt % of the polymeric ionic liquid.

7. The negative electrode as defined in claim 1 wherein the coating is (ii) or (iv) and wherein one of:
the VEC polymer is formed from the vinyl ethylene carbonate and an ultraviolet (UV) initiator, and the UV initiator is present in amount ranging from greater than 0 wt % to about 5 wt % based on the total wt % of the VEC polymer; or
the VEC polymer is formed from the vinyl ethylene carbonate and a thermal initiator, and the thermal initiator is present in amount ranging from greater than 0 wt % to about 5 wt % based on the total wt % of the VEC polymer.

8. The negative electrode as defined in claim 7 wherein one of:
the VEC polymer is formed from the vinyl ethylene carbonate and the UV initiator and the UV initiator is methyl benzoylformate; or
the VEC polymer is formed from the vinyl ethylene carbonate and the thermal initiator and the thermal initiator is azobisisobutyronitrile, benzoyl peroxide, or a combination thereof.

9. The negative electrode as defined in claim 1 wherein the coating is (iii) or (iv) and wherein one of:
the homo-polymer is formed from the ethylene glycol methyl ether methacrylate, the triethylene glycol methyl ether methacrylate, or the polyethylene glycol methyl ether methacrylate and a crosslinker selected from the group consisting of poly(ethylene glycol) dimethacrylate, 2,4,6,8-tetramethyl-2,4,6,8-tetravinylcyclotetrasiloxane, and combinations thereof, and the crosslinker is present in amount ranging from greater than 0 wt % to about 10 wt % based on the total wt % of the homo-polymer; or
the homo-polymer is formed from the ethylene glycol methyl ether methacrylate, the triethylene glycol methyl ether methacrylate, or the polyethylene glycol methyl ether methacrylate and an ultraviolet (UV) initiator, the UV initiator is methyl benzoylformate, and the UV initiator is present in amount ranging from greater than 0 wt % to about 5 wt % based on the total wt % of the homo-polymer; or
the homo-polymer is formed from the ethylene glycol methyl ether methacrylate, the triethylene glycol methyl ether methacrylate, or the polyethylene glycol methyl ether methacrylate and a thermal initiator selected from the group consisting of azobisisobutyronitrile, benzoyl peroxide, and a combination thereof, and the thermal initiator is present in amount ranging from greater than 0 wt % to about 10 wt % based on the total wt % of the homo-polymer.

10. The negative electrode as defined in claim 1 wherein the coating has a thickness ranging from about 500 nm to about 5000 nm.

11. The negative electrode as defined in claim 1 wherein the coating is (iv) and wherein:
the polymeric ionic liquid is present in an amount ranging from greater than 0 wt % to about 90 wt % based on a total wt % of the coating;
the VEC polymer is present in amount ranging from greater than 0 wt % to about 50 wt % based on the total wt % of the coating; and
the homo-polymer is present in amount ranging from greater than 0 wt % to about 50 wt % based on the total wt % of the coating.

12. A lithium-based battery, comprising:
a negative electrode, including:
a lithium metal active material; and
a coating disposed on the lithium metal active material, the coating consisting of one of:
(i) a polymeric ionic liquid; or
(ii) a VEC polymer formed from vinyl ethylene carbonate; or
(iii) a homo-polymer formed from ethylene glycol methyl ether methacrylate, triethylene glycol methyl ether methacrylate, or polyethylene glycol methyl ether methacrylate; or
(iv) a combination of any two or more of (i), (ii), and (iii);
a positive electrode; and
a microporous polymer separator soaked in an electrolyte solution, the microporous polymer separator being disposed between the positive electrode and the negative electrode.

13. The lithium-based battery as defined in claim 12 wherein the electrolyte solution includes a lithium salt dissolved in an ionic liquid, the ionic liquid including:
a cation selected from the group consisting of a pyrrolidinium-based cation, a piperidinium-based cation, and combinations thereof; and
a fluorosulfonyl imide-based anion.

14. A method for forming a negative electrode, the method comprising:
providing a lithium metal electrode;
applying a coating precursor on the lithium metal electrode, wherein the coating precursor consists of one of:
(a) an ionic liquid including:
a cation selected from the group consisting of a pyrrolidinium-based cation, a piperidinium-based cation, and combinations thereof, wherein the cation has a vinyl or allyl group thereon; and
an anion selected from the group consisting of bis(fluorosulfonyl)imide, bis(trifluoromethanesulfonyl)imide, and combinations thereof; or
(b) vinyl ethylene carbonate; or
(c) ethylene glycol methyl ether methacrylate, triethylene glycol methyl ether methacrylate, or polyethylene glycol methyl ether methacrylate; or
(d) a combination of any two or more of (a), (b), and (c); and
polymerizing the coating precursor directly on the lithium metal electrode, thereby forming a coating on the lithium metal electrode.

15. The method as defined in claim 14 wherein the coating precursor is (a) or (c) and the method further comprises applying a crosslinker on the lithium metal electrode, the crosslinker being selected from the group consisting of poly(ethylene glycol) dimethacrylate, 2,4,6,8-tetramethyl-2,4,6,8-tetravinylcyclotetrasiloxane, and combinations thereof, and wherein the polymerizing of the coating precursor utilizes the crosslinker.

16. The method as defined in claim 14, further comprising applying an ultraviolet (UV) initiator on the lithium metal electrode, the UV initiator being methyl benzoylformate, and wherein the polymerizing of the coating precursor utilizes the UV initiator.

17. The method as defined in claim 14, further comprising applying a thermal initiator on the lithium metal electrode, the thermal initiator being selected from the group consisting of azobisisobutyronitrile, benzoyl peroxide, and a combination thereof, and wherein the polymerizing of the coating precursor utilizes the thermal initiator.

18. The method as defined in claim 14 wherein the applying of the coating precursor is accomplished without a solvent.

19. The method as defined in claim 14 wherein the polymerizing of the coating precursor is accomplished by exposing the lithium metal electrode with the coating precursor thereon to ultraviolet (UV) light, a heat treatment, or a plasma treatment.

20. The method as defined in claim 14 wherein the coating consists of a polymer formed by polymerizing the coating precursor.
